(19) United States
(12) Patent Application Publication
(10) Pub. No.: US 2018/0173547 A1
(43) Pub. Date: Jun. 21, 2018

(54) PINNING OF VIRTUAL NETWORK FUNCTION (VNF) DEPLOYMENTS USING HARDWARE METRICS

(71) Applicant: Intel Corporation, Santa Clara, CA (US)

(72) Inventors: Ian Stokes, Shannon (IE); Andrey Chilikin, Limerick (IE)

(21) Appl. No.: 15/385,561

(22) Filed: Dec. 20, 2016

(51) Int. Cl. G06F 9/455; G06F 9/445

(52) U.S. Cl. CPC G06F 9/45533; G06F 8/60

(57) ABSTRACT

A computer-implemented method can include a non-uniform memory access (NUMA) system deploying a virtual network function (VNF) to one or more cores of a first central processing unit (CPU) on a first socket of a host. The system can also include a Control Deployment Manager (CDM) for monitoring one or more data transmission metrics associated with the first socket. Responsive to the CDM determining that a more optimal configuration for the VNF may exist based on the monitored data transmission metric(s), the NUMA system can re-deploy the first VNF to at least one other core.

### TECHNICAL FIELD

The disclosed technology relates generally to virtual machines (VMs), virtual central processing units (vCPUs), virtual network functions (VNFs), and associated memory on non-uniform memory access (NUMA) systems.

### BACKGROUND

FIG. 1 is a functional block diagram illustrating an example of a typical host device 100. In the example, the host device 100 includes a processor 102 for executing instructions as well as a memory 104 for storing such instructions. The memory 104 may include random access memory (RAM), flash memory, hard disks, solid state disks, optical disks, or any suitable combination thereof. The host device 100 also includes also includes a network communication interface 106 for enabling the host device 100 to communicate with at least one other device 108, such as an external or otherwise remote device, by way of a communication medium such as a wired or wireless packet network, for example. The host device 100 may thus transmit data to and/or receive data from the other device(s) via the network communication interface 106.

FIG. 2 is a functional block diagram illustrating an example of a typical host device 200, such as the host device 100 of FIG. 1, having a hardware platform 201 (such as an x86 architecture platform, for example), a virtual hardware platform 211, and a virtual machine execution space 221. In the example, the hardware platform 211 includes a processor 212, a memory 214, and a network communication interface 216. Multiple virtual machines (VMs) 222A-n can be concurrently instantiated and executed within the VM execution space.

FIG. 3 is a functional block diagram illustrating an example of a typical non-uniform memory access (NUMA) system 300. In the example, the NUMA system 300 includes two NUMA nodes 301, 311. The first node 301 includes a central processing unit (CPU) 302 and a memory 304, and the second node 311 includes a CPU 312 and a memory 314. Each CPU 301, 311 has a plurality of cores, here 16 cores. The cores on a certain node may each access the memory local to that node. For example, cores 0-15 of the first node CPU 302 may each access the first node memory 304.

The nodes 301, 311 may access each other through an interconnect 350, such as the Intel® QuickPath Interconnect (QPI), that supports data transmission between the nodes 301, 311. In the system 300, virtual CPU (vCPU) processes executed by virtual machines may be mapped to the physical CPUs 302, 312. Such mapping may be performed for the execution of virtual network functions (VNFs).

### BRIEF DESCRIPTION OF THE DRAWINGS

The concepts described herein are illustrated by way of example and not by way of limitation in the accompanying figures. For simplicity and clarity of illustration, elements illustrated in the figures are not drawn to scale unless otherwise noted.

FIG. 1 is a functional block diagram illustrating an example of a typical host device that includes a processor, a memory, and a network communication interface.

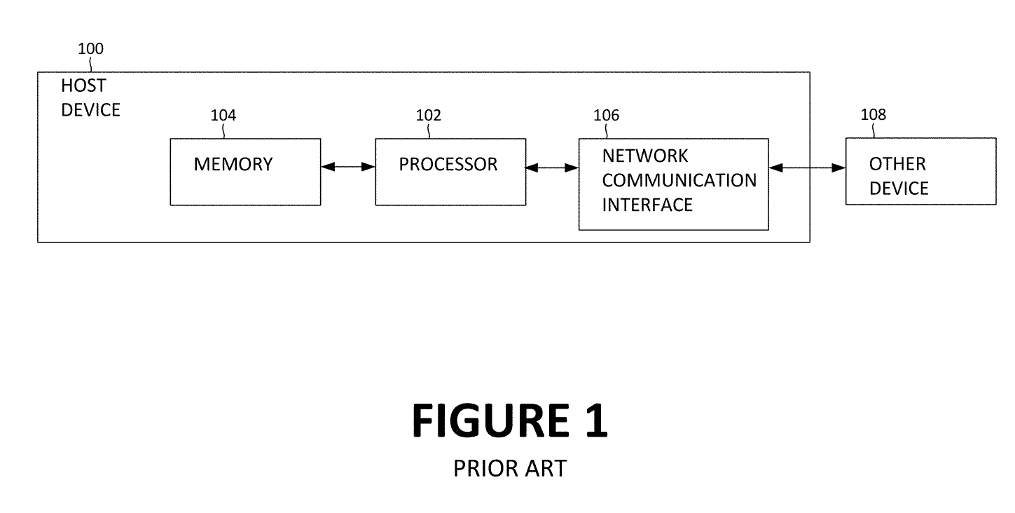

FIG. 2 is a functional block diagram illustrating an example of a typical host device having a hardware platform, a virtual hardware platform, and a virtual machine execution space.

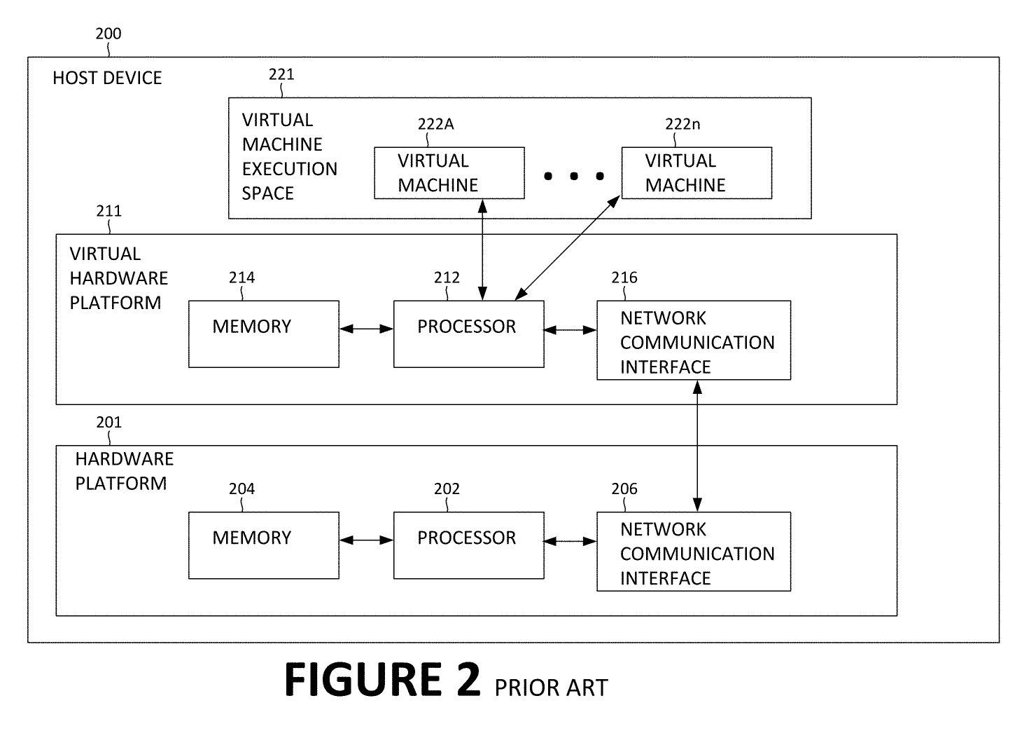

FIG. 3 is a functional block diagram illustrating an example of a typical non-uniform memory access (NUMA) system.

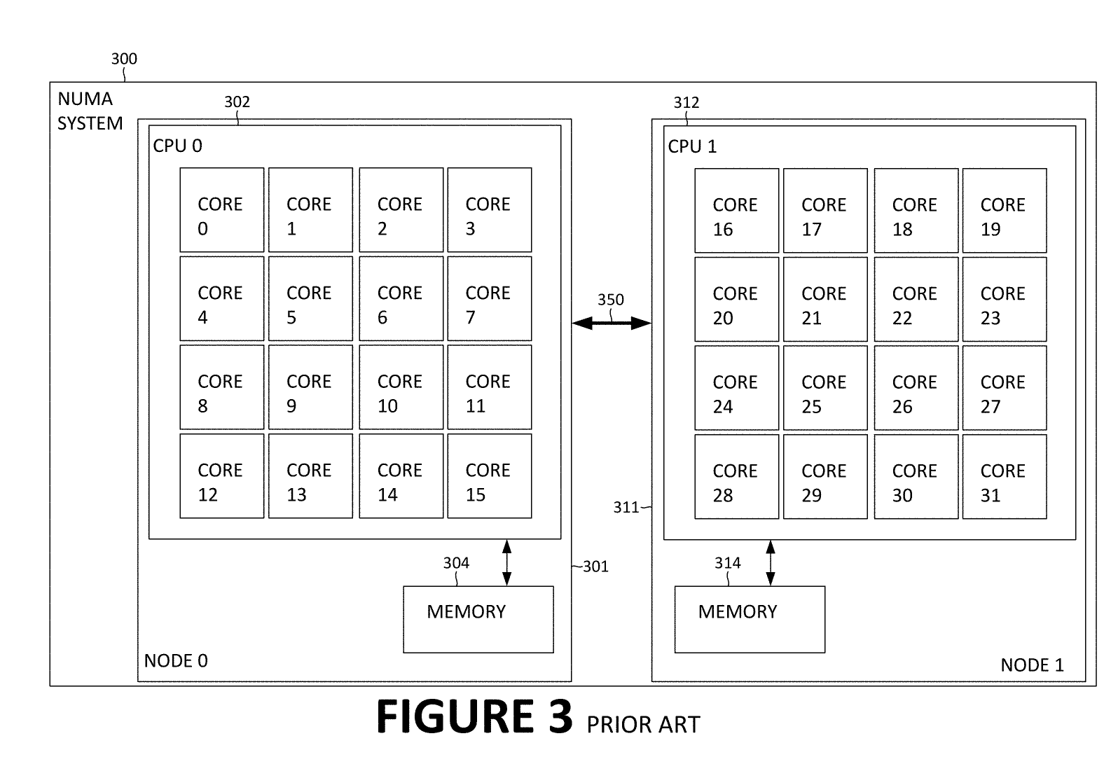

FIG. 4A is a functional block diagram illustrating a first state of a first embodiment of a NUMA system in accordance with the disclosed technology.

FIG. 4B is a functional block diagram illustrating a second state of the first embodiment of a NUMA system in accordance with the disclosed technology.

FIG. 4C is a functional block diagram illustrating a third state of the first embodiment of a NUMA system in accordance with the disclosed technology.

FIG. 5A is a functional block diagram illustrating a first state of a second embodiment of a NUMA system in accordance with the disclosed technology.

FIG. 5B is a functional block diagram illustrating a second state of the second embodiment of a NUMA system in accordance with the disclosed technology.

FIG. 5C is a functional block diagram illustrating a third state of the second embodiment of a NUMA system in accordance with the disclosed technology.

FIG. 6A is a functional block diagram illustrating a first state of a third embodiment of a NUMA system in accordance with the disclosed technology.

FIG. 6B is a functional block diagram illustrating a second state of the third embodiment of a NUMA system in accordance with the disclosed technology.

FIG. 6C is a functional block diagram illustrating a third state of the third embodiment of a NUMA system in accordance with the disclosed technology.

FIG. 7A is a functional block diagram illustrating a first state of a fourth embodiment of a NUMA system in accordance with the disclosed technology.

FIG. 7B is a functional block diagram illustrating a second state of the fourth embodiment of a NUMA system in accordance with the disclosed technology.

FIG. 7C is a functional block diagram illustrating a third state of the fourth embodiment of a NUMA system in accordance with the disclosed technology.

FIG. 7D is a functional block diagram illustrating a fourth state of the fourth embodiment of a NUMA system in accordance with the disclosed technology.

FIG. 7E is a functional block diagram illustrating a fifth state of the fourth embodiment of a NUMA system in accordance with the disclosed technology.

FIG. 8 is a flow diagram illustrating a first example of a computer-implemented method in accordance with certain embodiments of the disclosed technology.

FIG. 9 is a flow diagram illustrating a second example of a computer-implemented method in accordance with certain embodiments of the disclosed technology.

### DETAILED DESCRIPTION OF THE DRAWINGS

VNFs typically require a high-packet throughput. One way to ensure such high performance is a process that includes affinitizing (also referred to herein as pinning) a vCPU within a VM to one or more CPUs residing on a host platform. However, this is generally a difficult task as host platforms can be multi-socketed, and some multi-socketed hosts can contain multiple NUMA nodes per socket. In order to provide adequate throughput for VNFs, such factors must be considered when pinning vCPUs to host CPUs.

Pinning vCPUs to logical CPUs that are located on different sockets will require traffic to traverse a QPI link connecting the sockets. This typically results in reduced performance due to the bandwidth limitation of the QPI link. But, even in situations where a vCPU is pinned to a CPU on an optimal socket, other problems exist. Consider an example in which a socket is divided internally between two NUMA nodes using a technology such as Cluster-on-Die (COD). Such arrangement may result in a problem where vCPUs are pinned to CPUs on the same socket but a performance penalty is incurred because the CPUs on the host system do not share equal access to the system memory.

Prior attempted solutions to such problems have included the use of a topology map of the CPUs on each socket in order to decide which CPU should be selected so as to avoid the QPI penalty between sockets. However, such arrangements do not accommodate the single-socket multiple-NUMA-node situations and, further, do not take VNF usage into account where the amount of traffic being processed may increase and decrease over time. Indeed, prior attempted solutions such as pinning vCPUs based on a known topology of the host do not take performance metrics of the underlying host into account. Further, once a vCPU is pinned to a CPU, such topology solutions are unable to determine whether a more optimal solution may be available based on the CPU usage of the host.

Problems such as those described above are also known to occur in attempted solutions that use affinity or anti-affinity rules. Affinity rules can be used to ensure that a VM is deployed on a particular host only but, once the VM is deployed, affinity rules have no way of determining whether there is a more optimal deployment for the VM on the host. Consider an example in which two VMs are communicating with each other but the VMs are deployed to different sockets on the same host system. In this example, the affinity rule has been satisfied because the VMs have been deployed on a particular host, but overhead introduced by data traveling between the VMs over the QPI bus on the host is not taken into consideration.

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, such feature, structure, or characteristic can be employed in connection with another disclosed embodiment whether or not such feature is explicitly described in conjunction with such other disclosed embodiment.

The disclosed embodiments may be implemented, in some cases, in hardware, firmware, software, or any combination thereof. The disclosed embodiments may also be implemented as instructions (e.g. a computer program product) carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

Embodiments of the disclosed technology generally pertain to techniques and mechanisms for improved pinning of virtual network function (VNF) deployments using metrics. Certain implementations generally include automatically pinning a virtual central processing unit (vCPU) configuration based on system metric data, such as CPU metrics and memory metrics, and responding in a dynamic manner to find a more optimal setup for a given VNF deployment. In such implementations, a Control Deployment Manager (CDM) can be used for deploying one or more virtual machines (VMs) on a platform. The CDM can be implemented as a hardware component, software component, or combination of hardware and software.

In certain implementations, the CDM may be used to collect specific platform CPU/hardware metrics, e.g., by monitoring an interconnect between two or more host CPUs, and use such metrics to make an informed decision for improved pinning of vCPUs to host CPUs. More optimal pinning generally ensures increased performance for a VNF deployment by avoiding greater-than-needed distance between an interconnect and a node, for example. Such implementations may also advantageously avoid memory, e.g., L2/L3 cache, hit penalties.

The monitored metrics that can be used in the determination of improved vCPU pinning may include interconnect data rates as well as CPU memory cache hit and miss rates, for example. Interconnect data rates are generally reported in terms of bytes (e.g., kB/MB/GB) and represent the amount of data passing between CPU sockets on the system.

In situations where the CDM detects a high interconnect data rate, such information may signify a sub-optimal vCPU pinning schema. The CDM can then pin vCPUs for any VMs present on the system to an alternative CPU on another socket on the host. The CDM may repeat this for each VM on the system, e.g., in a round robin manner. The CDM may also record the interconnect data rates after each pinning and, in certain embodiments, review the data rate for each pinning configuration. The vCPU pinning configuration having the lowest interconnect data rate is typically selected as the optimal configuration. Because traffic loads can change dynamically for VMs, the process may be repeated to ensure that the selected configuration is still the most optimal and, if not, the newly-designated most optimal pinning schema configuration may be recorded and selected.

Alternatively or in addition thereto, the CDM can monitor cache, e.g., L3 and L2, hit and miss metrics for specific cores on a host to determine a most optimal pinning with regard to a NUMA layout on a given socket. The CDM may also record the hit and miss rates after each pinning and, in certain embodiments, review the information for each pinning configuration.

In certain implementations, the CDM can use the optimization mechanism as often as desired to respond to performance requirements of a given VNF deployment as its traffic profile changes over time. Also, depending on what case the platform is being optimized for, a user may use different input data. For example, the CDM can monitor power usage of the platform and correlate it with the VM deployment to reduce such power usage as well as operational cost.

As noted above, existing attempted solutions such as affinity/anti-affinity rules-based techniques and topology mapping of CPUs and sockets do not provide such metric data (e.g., interconnect data rates and L2/L3 cache hits and misses) and, as such, these prior systems cannot guarantee a more optimal vCPU pinning schema for a given single socket system.

Further, certain implementations of the disclosed technology may advantageously enable a more optimal deployment of VNFs on multi-socket and multi-NUMA node platforms, thereby increasing flexibility and performance of deployments as hardware data metrics can be gathered and acted upon in a real-time, automated manner by such optimal pinning mechanisms. Because metrics can be determined real-time, e.g., while a VNF/NFV is operating, embodiments disclosed herein can also be flexible, which is important in a fast-changing environment where VNFs may have varying levels of throughput and usage can require a change in deployment configuration to ensure a more optimal performance.

Implementations of the disclosed technology may be integrated with cloud deployment and management platforms, such as OpenStack, for example, because the metrics collected by the mechanisms described herein can be provided to an orchestrator to make informed decisions regarding VM deployments. Such functionality can be useful when deploying VMs on a service-assured basis where there is more certainty as to the performance of the VM being provisioned.

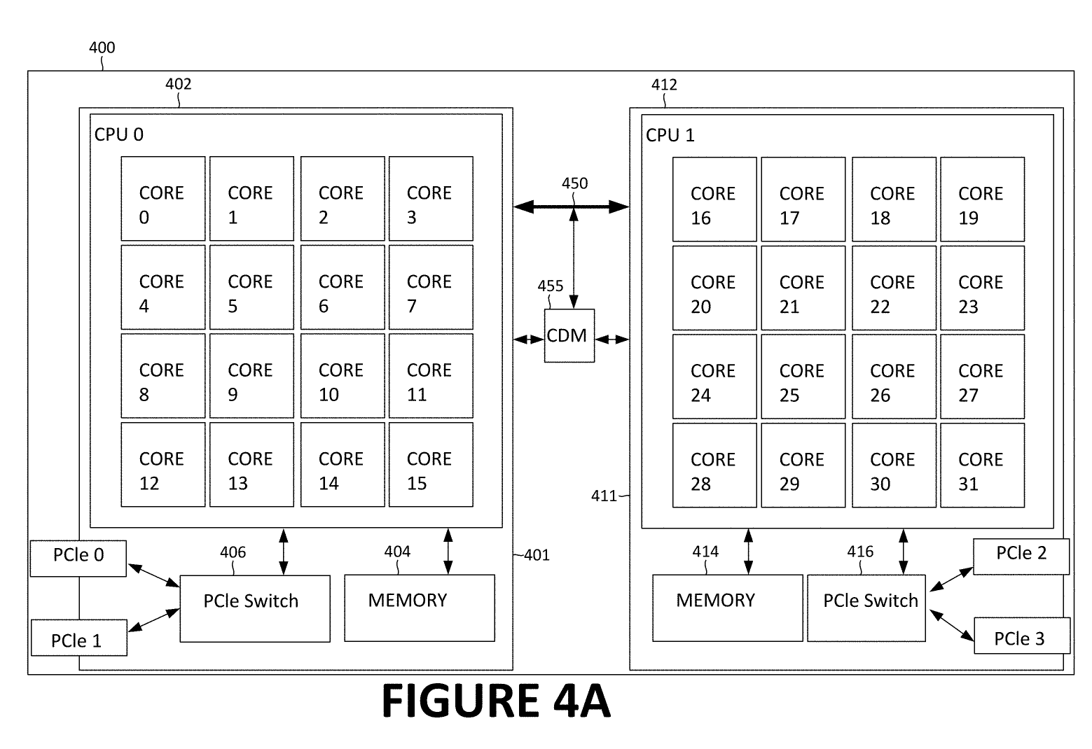

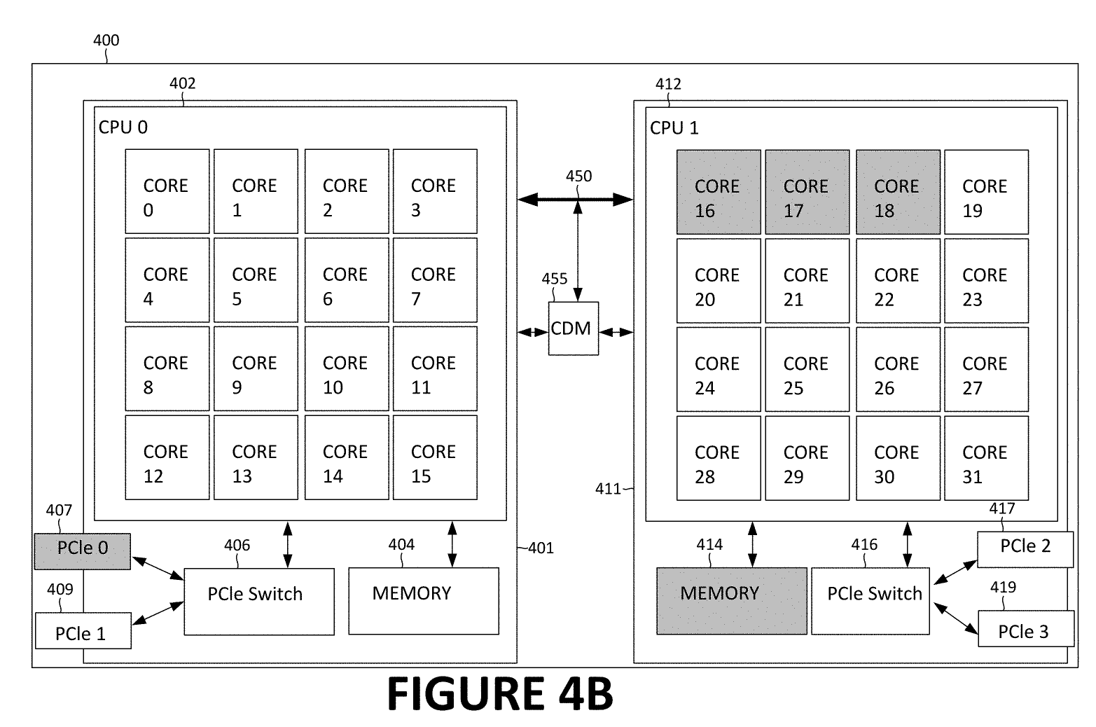

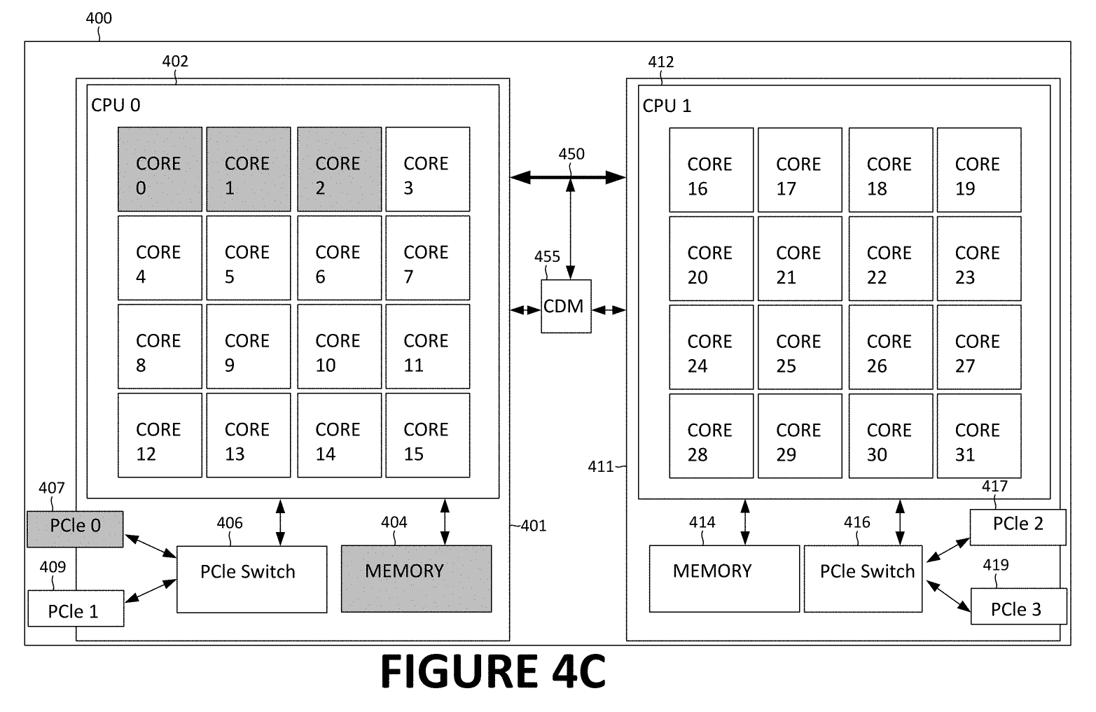

FIG. 4A is a functional block diagram illustrating a first state of a first embodiment of a NUMA system 400 in accordance with the disclosed technology. In the example, the system 400 includes a two-socket platform. The two sockets 402, 412, each have 16 physical cores per CPU. The system 400 also includes a network interface card (NIC) (not shown) that is attached via Peripheral Component Interconnect Express (PCIe) on PCIe 0. The NIC can create single root input-output virtualization (SR-IOV) virtual functions (VFs) to be used by guest virtual machines (VMs) on the system 400.

An interconnect 450, such as the Intel® QuickPath Interconnect (QPI), facilitates data transmission between the two socket 402, 412, and a Control Deployment Manager (CDM) 455 can monitor metrics associated with the interconnect 450. In the example, when the system 400 is idle, the output traffic and data is measured by the CDM 455 to be 1215 kB, and usage for each of the sockets 402, 412 is essentially 0%.

In the example, the guest VMs are VNFs that process traffic. The more optimal their setup in terms of vCPU-to-CPU pinning, the higher traffic throughput they will reach. Data traffic can enter the system 400 by way of the NIC attached to PCIe 0 and can then be forwarded by way of the SR-IOV to the VM. The guest can perform packet processing before transmitting the data traffic back to the NIC. In the example, the VNF requires three vCPUS, where each vCPU is to be pinned to a corresponding CPU on the system 400.

FIG. 4B is a functional block diagram illustrating a second state of the first embodiment of a NUMA system 400 in accordance with the disclosed technology. The NIC is attached directly to CPU 0 on the first socket 402 by way of PCIe 0 and has multiple SR-IOV virtual interfaces for use with VNFs. However, here the VNF is deployed with three cores (i.e., Cores 16, 17, and 18) on CPU 1 on the second socket 412 and will primarily access the memory 414 attached to the second socket 412. This is sub-optimal because ingress traffic received at the NIC at the first socket 402 must be processed by CPUs, e.g., CPU 1, on the second socket 412, which requires the interconnect 450 to be traversed between the two sockets 402, 412 and, as such, the interconnect 450 undesirably becomes a functional bottleneck that results in a performance penalty for the VNF.

The CDM 455 can obtain a reading of the interconnect 450 metrics on the system 400. The interconnect 450 usage for socket 0 and 1 has increased and, in the example, the outgoing data and traffic reading monitored by the CDM 455 is now 5618 MB per second. This reading, compared to the idle reading, indicates a high overhead associated with the particular VNF deployment. A high interconnect 450 data rate could infer that the vCPUs are each pinned to a sub-optimal or even incorrect socket.

Based on these monitored metrics, the CDM can cause the vCPUs to be pinned to cores attached to CPU 0 (i.e., Cores 0, 1, and 2), as shown by FIG. 4C, which is a functional block diagram illustrating a third state of the first embodiment of a NUMA system 400 in accordance with the disclosed technology. In certain implementations, the CDM can cause a taskset or process managing tool such as htop to pin process IDs of the hypervisor that is running a specific VM. For example, the hypervisor may be a Quick Emulator (QEMU) that pins identified processes to specific cores using a taskset responsive to identifying process IDs associated with a particular VM that is being run by the QEMU.

In the example, the VNF is deployed to use cores (i.e., Cores 0, 1, and 2), memory 404, and an NIC that are all attached to CPU 0 on the first socket 402. The CDM can then read the interconnect 450 metrics again and, in the example, determine that outgoing traffic and data on the interconnect 450 has dropped from 5618 M to 421 M per second. Thus, the interconnect 450 is no longer a functional bottleneck. As can be seen from this example, the measuring of interconnect metrics can be used to determine more optimal deployments of VNFs on a multi-socket system.

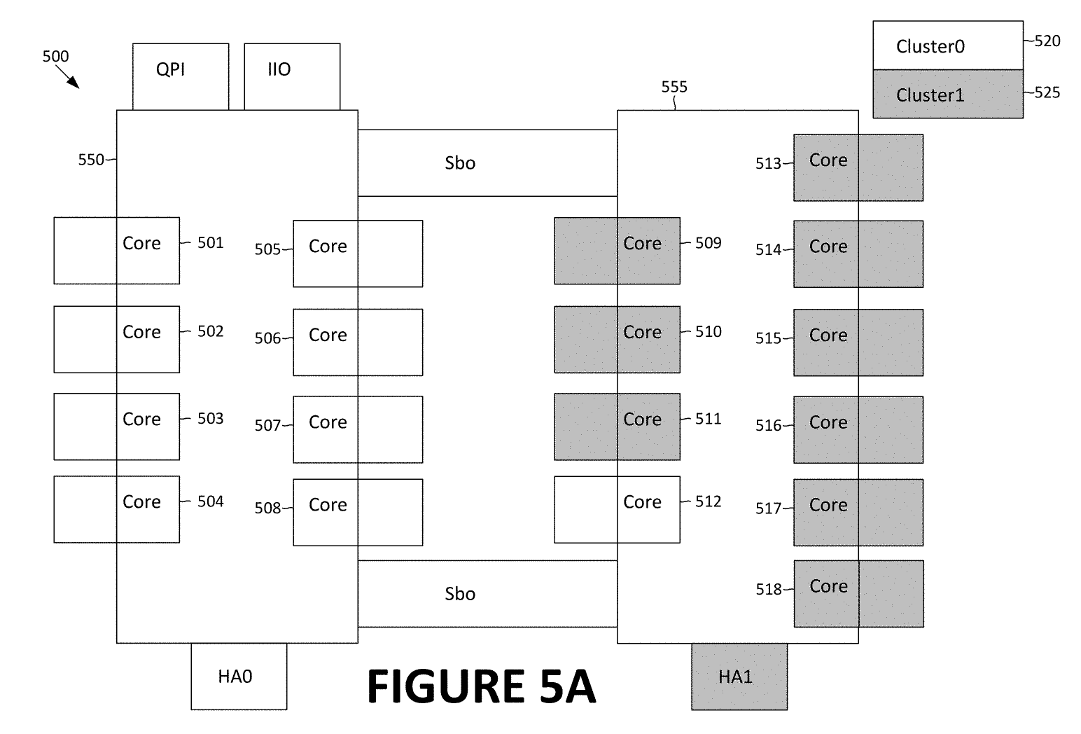

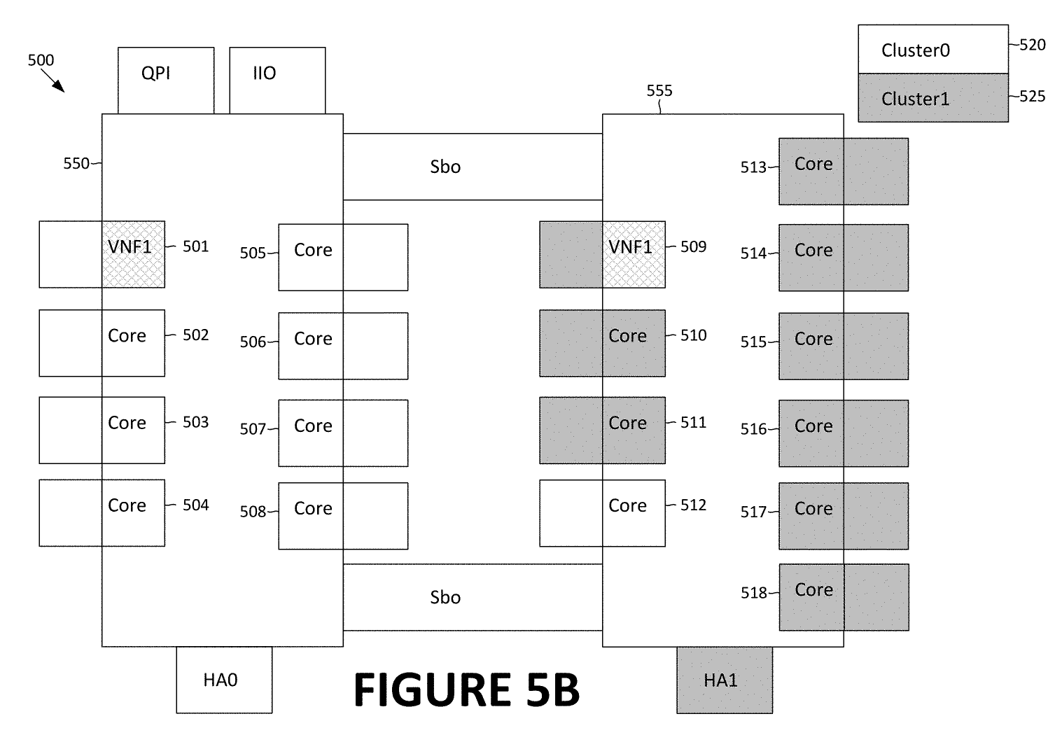

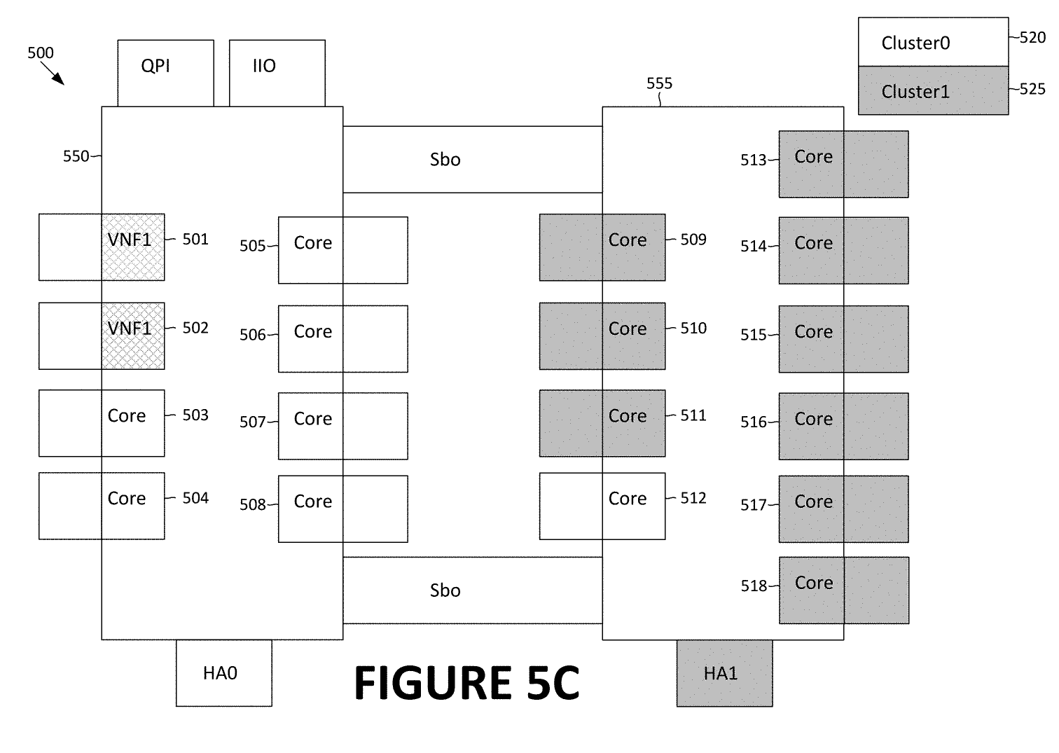

FIG. 5A is a functional block diagram illustrating a first state of a second embodiment of a NUMA system 500 in accordance with the disclosed technology. In the example, there are multiple NUMA nodes 550, 555 on a single socket and an 18-core Haswell having a first cluster 520 of cores (NUMA node 0, Cores 501-508 and 512) and a second cluster 525 of cores (NUMA node 1, Cores 509-511 and 513-518). In the example, the idle readings monitored by a CDM (not shown) for L3/L2 miss rates are 10 kB and 76 kB, respectively, and the L3/L2 hit ratios are 86% and 53%, respectively.

In the example, the system 500 is hosting a user space application that uses HugePage memory as a performance optimization for network processing (e.g., the Data Plane Development Kit (DPDK)). HugePages can be specified dynamically on a per-NUMA-node basis for increased flexibility of deployment when being used with a VM. DPDK can also be used to provide optimized virtual interfaces such as VHOST USER for VNFs.

In certain situations, the HugePages can be allocated on NUMA node 0 but a VNF using DPDK vHost interfaces can be deployed with some or all of its vCPUs/cores on NUMA node 1, as shown by FIG. 5B, which is a functional block diagram illustrating a second state of the second embodiment of a NUMA system 500 in accordance with the disclosed technology. This example represents a sub-optimal deployment. As such, the CDM can obtain certain metrics as a base mark before and after the VNF has been deployed and determine a more optimal pinning based on a spike in the L3/L2 miss ratio and a drop in the L3/L2 hit ratio.

Comparing such metrics from before and after VNF deployment in the example shows that the L3/L2 miss data rates have increased to 19 M and 26 M, respectively, and further that the L3/L2 hit ratios have dropped to 28% and 40%, respectively. Upon identifying this spike and drop, the CDM can pin the vCPUs of the VNF to cores on NUMA node 0 (Cores 501 and 502), as shown by FIG. 5C, which is a functional block diagram illustrating a third state of the second embodiment of a NUMA system 500 in accordance with the disclosed technology.

The CDM can then obtain the L3/L2 metrics again and, in the example, observe an increase in hit rate along with an expected drop for missed data rate, thus confirming a more optimal pinning in a multi-NUMA-node single socket deployment.

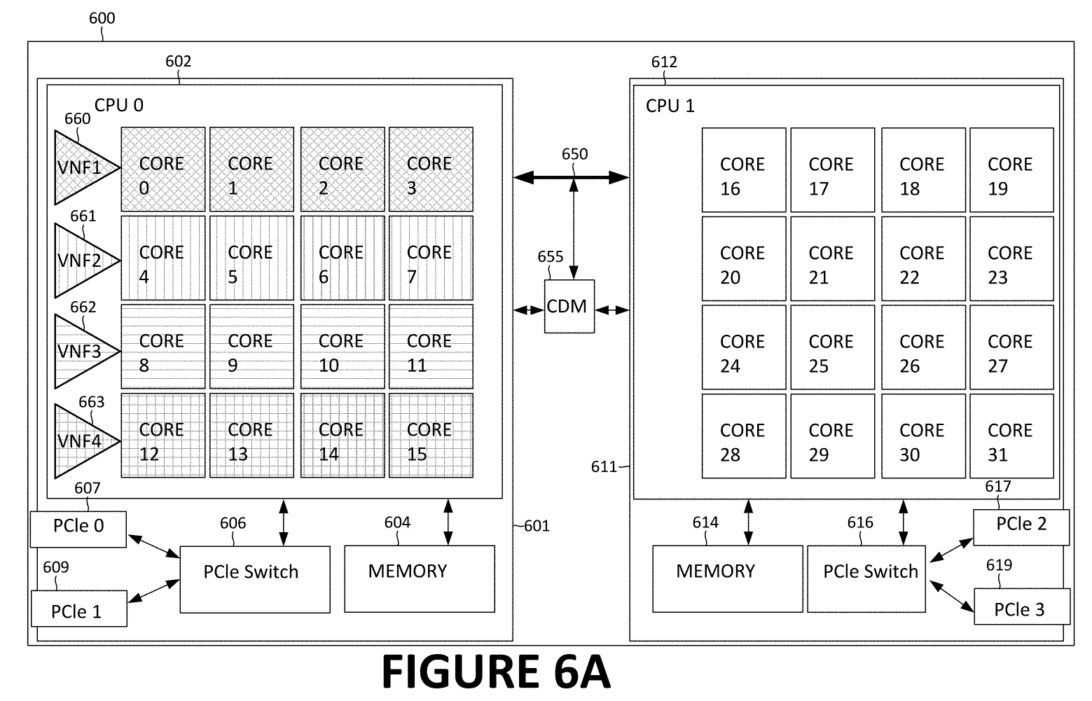

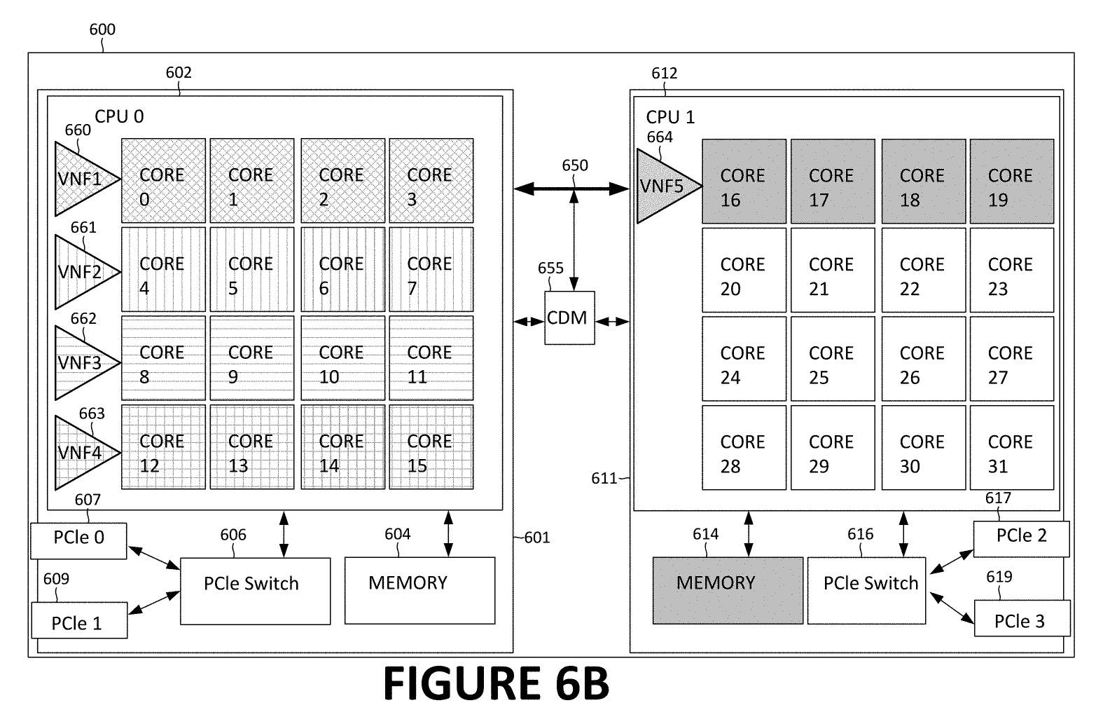

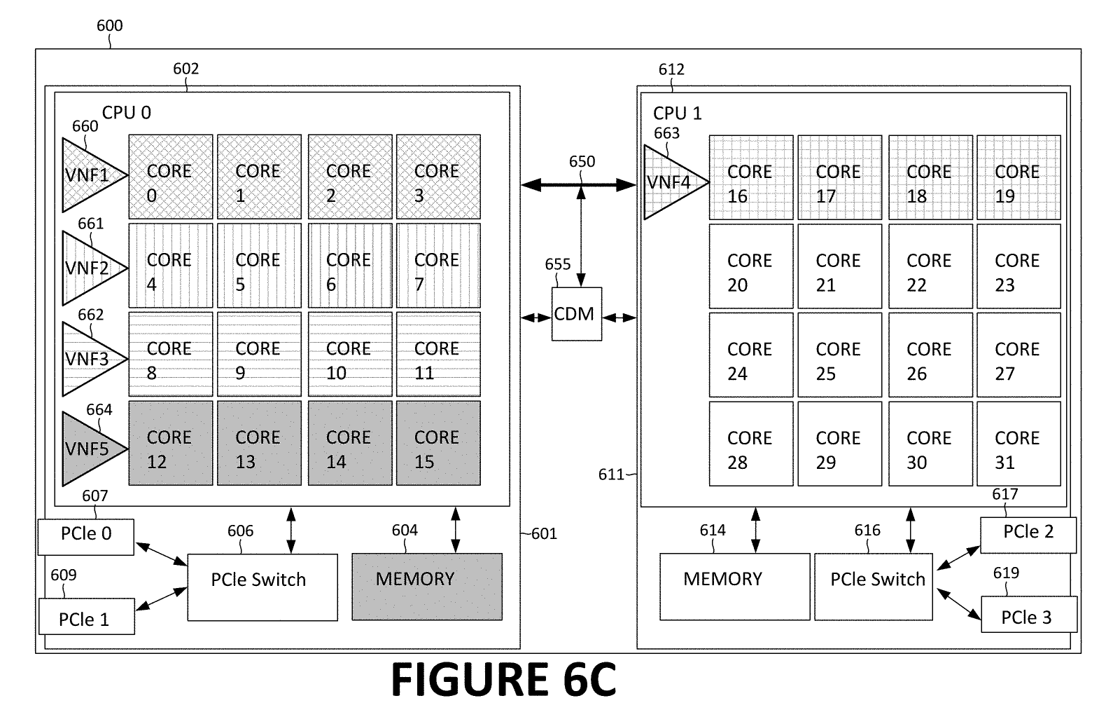

FIG. 6A is a functional block diagram illustrating a first state of a third embodiment of a NUMA system 600 in accordance with the disclosed technology. In the example, there are two sockets 602, 612 and multiple VNFs (i.e., VNF1, VNF2, VNF3, and VNF4) that have been deployed on CPU 0.

In the example, each VNF requires four vCPUs and all available cores on CPU 0 have been pinned to vCPUs of the VNFs, with a one-core-to-one-vCPU ratio. As such, there are no free cores remaining on the first socket 602.

In the example, a new VNF (i.e., VNFS) is introduced that requires optimal access to an NIC attached to the first socket 602. VNFS is deployed on CPU 1 on the second socket 612, as shown by FIG. 6B, which is a functional block diagram illustrating a second state of the third embodiment of a NUMA system 600 in accordance with the disclosed technology. By deploying VNFS on CPU 1 as shown, a 1:1 mapping is maintained. However, in the example, the CDM reads the interconnect metrics and determines that such metrics here indicate a sub-optimal pinning.

In the example, the CDM can base mark the current interconnect reading. The CDM can then attempt to swap the core-pinning of vCPUs associated with each VNF with the cores associated with VNFS on CPU 1, taking the reading after each pinning to identify the VNF that incurs the least interconnect overhead. For example, one of the VNFs may not have significant traffic destined for the NIC attached to the first socket 602 and, as such, pinning the VNF to cores on the socket that is not directly attached to the NIC could be acceptable.

Once the VNF having the least overhead is identified, the CDM can cause it to be pinned to the second socket 612, thus making cores on the first socket 602 available. This advantageously allows the new VNF that requires optimal access to the NIC to be deployed as shown by FIG. 6C, which is a functional block diagram illustrating a third state of the third embodiment of a NUMA system in accordance with the disclosed technology. In FIG. 6C, the pinnings of cores associated with VNF 5 and cores associated with VNF 4 have be swapped.

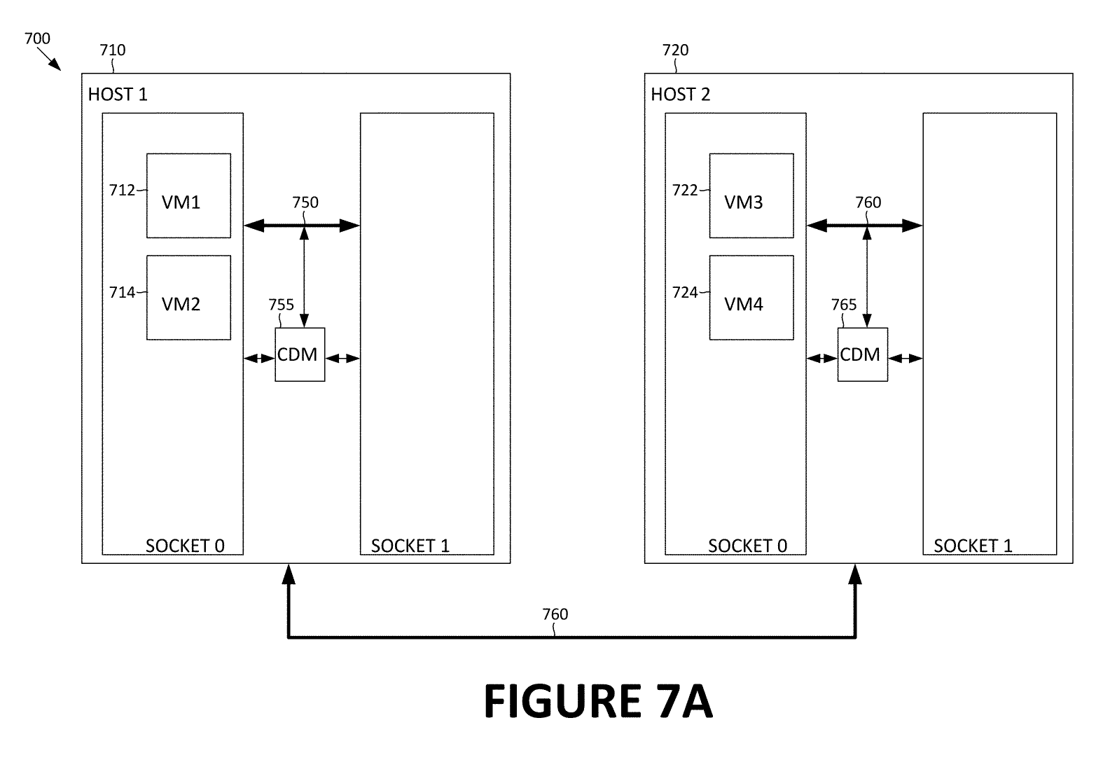

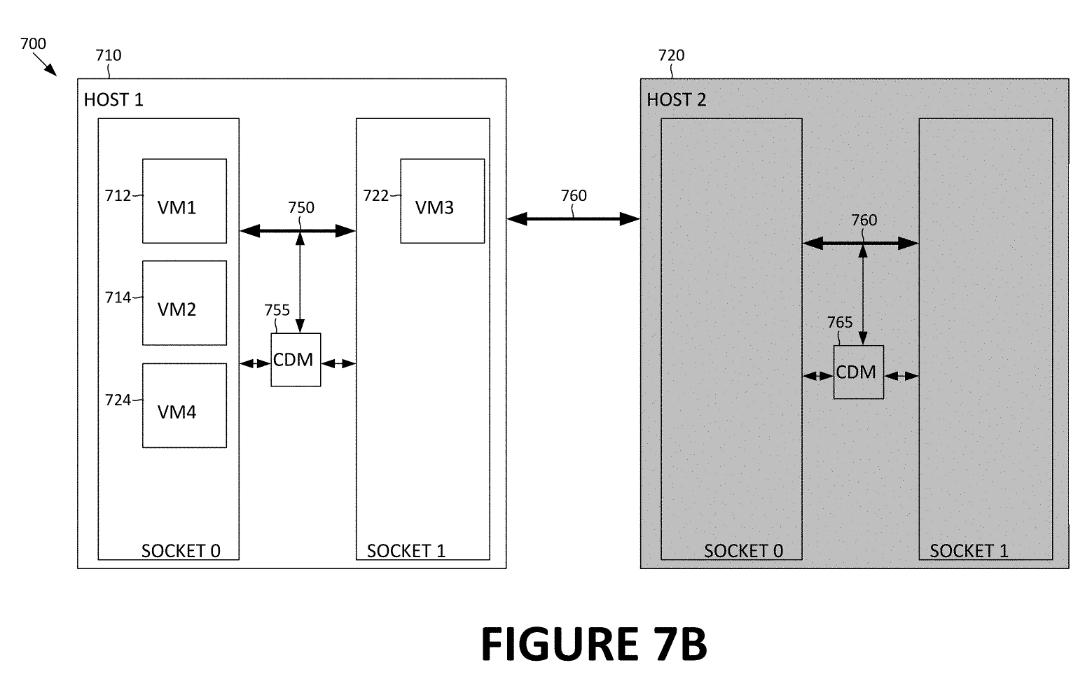

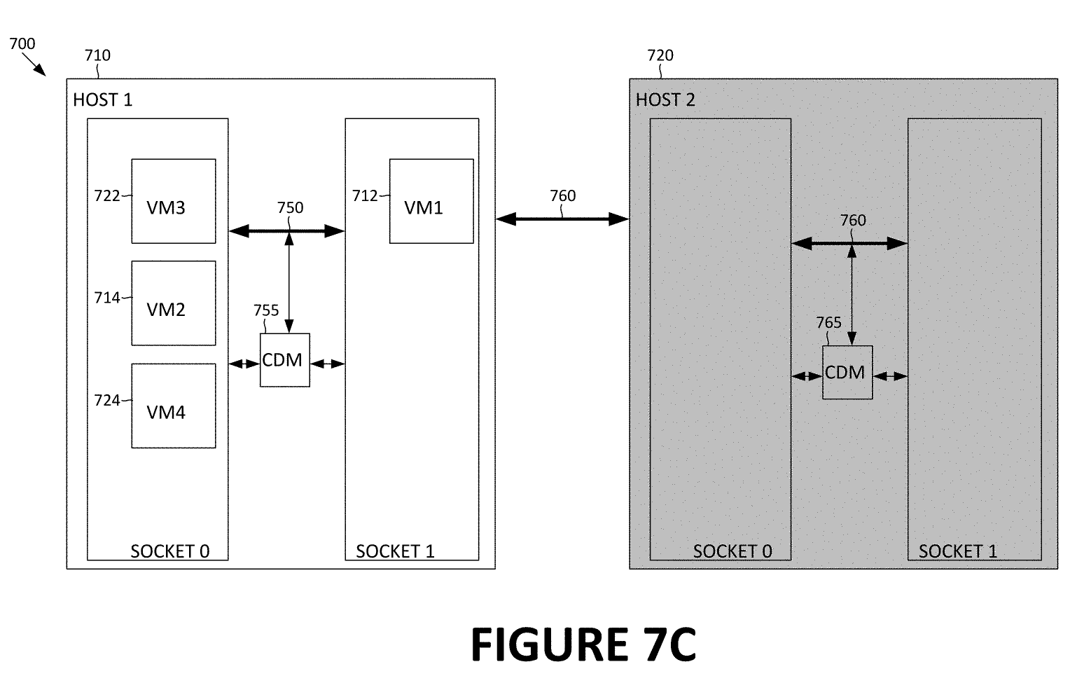

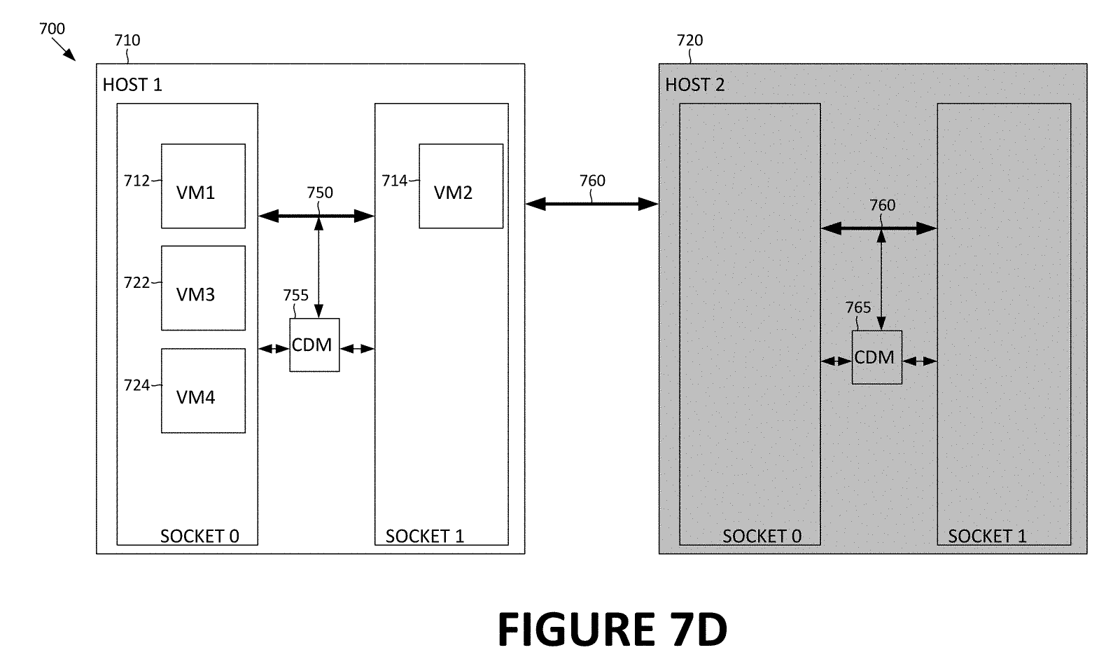

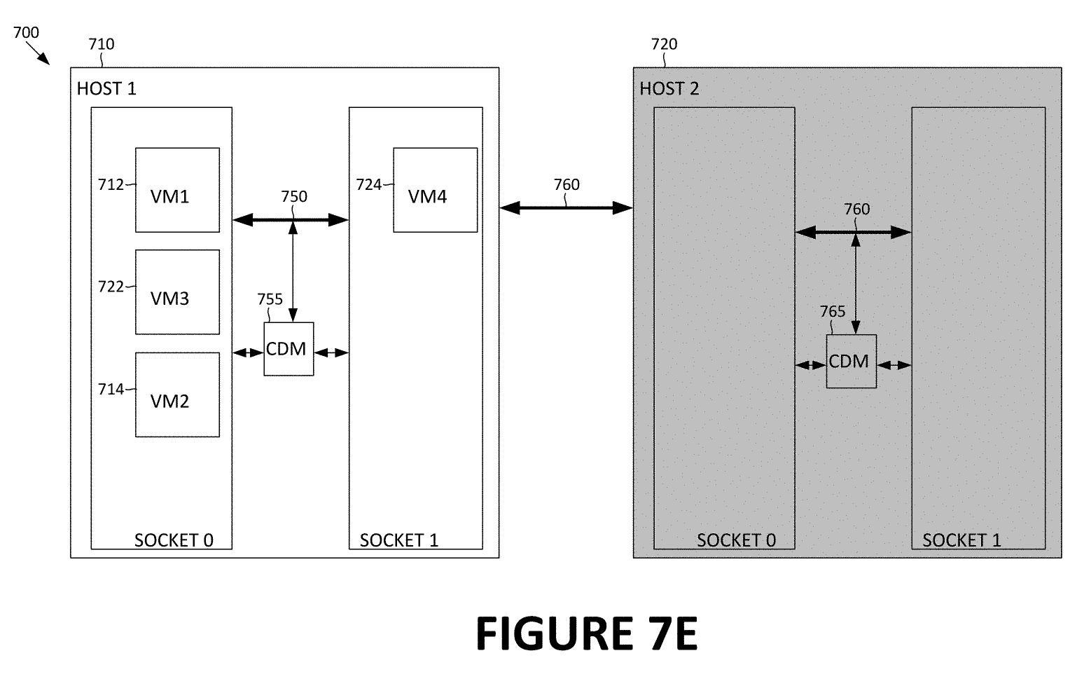

FIG. 7A is a functional block diagram illustrating a first state of a fourth embodiment of a NUMA system 700 in accordance with the disclosed technology. In the example, a first host 710 and a second host 720 are running multiple virtual machines (VMs). Two of the VMs, VM1 712 and VM3 722 are communicating with each other and, as such, there is a significant amount of data traffic 760 passing between the two hosts, Host 1 and Host 2. This type of communication is considered ‘North/South’ because the data traffic 760 is actively leaving Host 1 to be sent over the network to VM3 722 on Host 2.

In certain industries, e.g., telecommunications and enterprise, it is common practice to power down host platforms to conserve power at non-peak times in an effort to reduce operating expenses. In the example, before powering down Host 2, VM3 722 and VM4 724 are migrated from Host 2 to Host 1, as shown by FIG. 7B, which is a functional block diagram illustrating a second state of the fourth embodiment of a NUMA system 700 in accordance with the disclosed technology.

However, without the disclosed techniques, there is simply no way for the system 700 to know whether the vCPU pinning schema after the migration of VM3 722 and VM4 724 is optimal. For example, consider a situation in which VM3 is pinned to CPUs on the first socket 710 and VM4 is pinned to CPUs on the second socket 720. Here, VM1 712 and VM3 722 are still communicating and sending high volumes of data traffic 750 to one another. This data traffic 750 is considered ‘East/West’ traffic because the data traffic 750 does not leave Host 1 when being sent from VM1 712 to VM3 722. However, because the VMs do not reside on the same socket, the vCPU pinning is now not optimal. One metric that can be used to indicate this is the high volume of data crossing the interconnect 750 bridge when measured, e.g., by a CDM 755.

The system 700 can first swap VM1 712 and VM3 722, as shown by FIG. 7C, which is a functional block diagram illustrating a third state of the fourth embodiment of a NUMA system 700 in accordance with the disclosed technology. The CDM 755 can then check the interconnect 750 data rate, as VM1 712 and VM3 722 continue to transmit data traffic to each other. Here, the CDM 755 determines that the interconnect 750 data rate is still undesirably high, so the VM1-for-VM3 swap can be reversed and the next VM (i.e., VM2 714) can be swapped with VM3 722, as shown by FIG. 7D, which is a functional block diagram illustrating a fourth state of the fourth embodiment of a NUMA system 700 in accordance with the disclosed technology.

The CDM 755 can check the interconnect 750 data rate and determine that the rate is still undesirably high, even though traffic from VM1 712 and VM3 722 is not crossing the interconnect 750 anymore. This may indicate that VM2 714 is using an NIC attached to Socket 0 on Host 1. Regardless, because the monitored interconnect 750 rate is still too high, the VM2-for-VM3 swap can be reversed and the next VM (i.e., VM4 724) can be swapped with VM2 714, as shown by FIG. 7E, which is a functional block diagram illustrating a fifth state of the fourth embodiment of a NUMA system 700 in accordance with the disclosed technology.

The CDM 755 can again check the interconnect 750 data rate and determine that the rate is now the lowest recorded rate compared to the previous readings. This finding indicates that the most optimal VM deployment has been determined and the interconnect 750 bottleneck has been minimized for data traffic being transmitted and received to the VMs on Host 1.

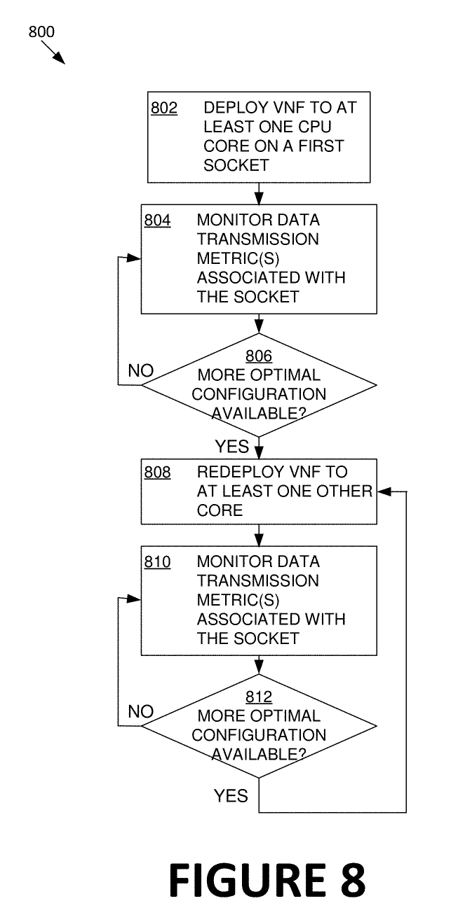

FIG. 8 is a flow diagram illustrating a first example of a computer-implemented method 800 in accordance with certain embodiments of the disclosed technology. At block 802, a VNF is initially deployed to at least one CPU core on a first socket, such as the deploying of the VNF illustrated by FIGS. 4A-4B to Cores 16, 17, and 18 on CPU 1 on the second socket 412. In certain embodiments, multiple VNFs may be deployed to multiple CPUs on one or more sockets.

At block 804, one or more data transmission metrics associated with the first socket are monitored. Such monitoring may be performed by a CDM such as the CDM 455 illustrated by FIG. 4B, for example. The monitored metrics may include interconnect data rates, drop rates, CPU metrics, memory metrics, other suitable metrics, or a combination thereof.

At block 806, a determination is made as to whether a more optimal configuration is available. For example, the CDM may determine that, based on the monitored metric(s), the current deployment is sub-optimal and, thus, a more optimal deployment is likely available.

At block 808, the VNF is re-deployed to at least one CPU core other than the core to which it was previously deployed, such as the re-deploying of the VNF illustrated by FIGS. 4B-4C to Cores 0, 1, and 2 on CPU 0 on the first socket 402. While the example illustrated by FIGS. 4B-4C involves the redeploying of a VNF to a core on a different socket it will be appreciated that, in certain embodiments, the VNF may be re-deployed to at least one other core that is on the same socket as that of the core to which it was previously assigned.

At block 810, one or more data transmission metrics are monitored. While such metrics monitored at 810 may be the same as the metrics monitored at 804, such does not necessarily need to be the case. That is, the metric(s) monitored after re-deployment may be the same or different as those that were monitored before the present redeployment of the VNF.

At block 812, a determination is made, e.g., by the CDM, as to whether a more optimal configuration is available based on the data transmission metric(s) monitored at 810. If the determination is that there may be a more optimal configuration available, the process reverts to block 808; otherwise, the monitoring of the data transmission metric(s) at 810 continues.

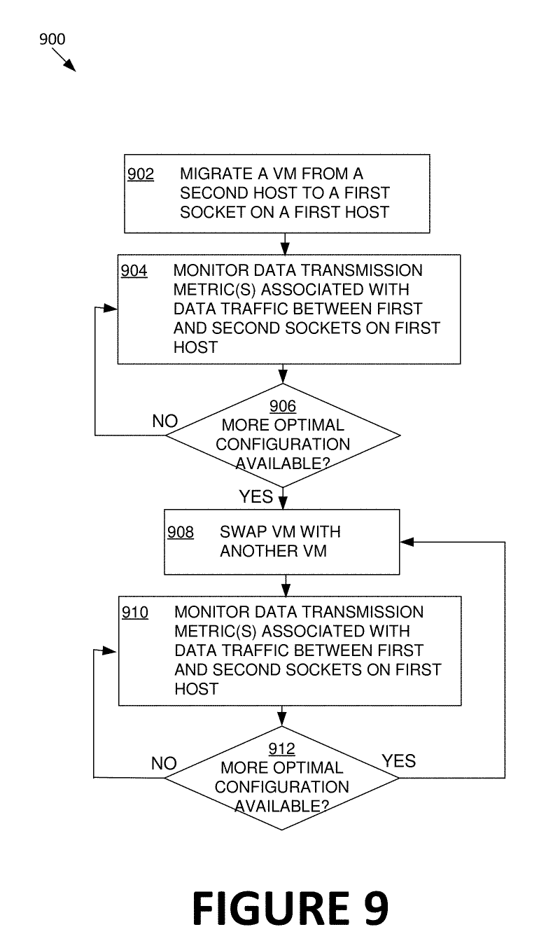

FIG. 9 is a flow diagram illustrating a second example of a computer-implemented method 900 in accordance with certain embodiments of the disclosed technology. At block 902, a VM is migrated from a second host to a first host, such as the migrating of the VM3 722 illustrated by FIGS. 7A-7B from the second host 720 to the first host 710.

At block 904, one or more data transmission metrics associated with the first host are monitored. Such monitoring may be performed by a CDM such as the CDM 755 illustrated by FIG. 7B, for example. The monitored metrics may include interconnect data rates, drop rates, CPU metrics, memory metrics, other suitable metrics, or a combination thereof.

At block 906, a determination is made as to whether a more optimal configuration is available. For example, the CDM may determine that, based on the monitored metric(s), the current deployment is sub-optimal and, thus, a more optimal deployment is likely available.

At block 908, the VM is swapped with another VM, such as the swapping of VM3 722 with VM1 712 illustrated by FIGS. 7B-7C. At block 910, one or more data transmission metrics are monitored. While such metrics monitored at 910 may be the same as the metrics monitored at 904, such does not necessarily need to be the case. That is, the metric(s) monitored after VM swapping may be the same or different as those that were monitored before the present VM swapping.

At block 912, a determination is made, e.g., by the CDM, as to whether a more optimal configuration is available based on the data transmission metric(s) monitored at 910. If the determination is that there may be a more optimal configuration available, the process reverts to block 908; otherwise, the monitoring of the data transmission metric(s) at 910 continues. It will be appreciated that there can be virtually any number VM swaps made before a more optimal configuration is obtained, such as in the example illustrated by FIGS. 7A-7E, which involves multiple VM swaps before a more optimal configuration is obtained.

### EXAMPLES

Illustrative examples of the technologies disclosed herein are provided below. An embodiment of the technologies may include any one or more, and any combination of, the examples described below.

Example 1 includes a computer-implemented method comprising: a non-uniform memory access (NUMA) system deploying a first virtual network function (VNF) to at least one core of a first central processing unit (CPU) on a first socket of a host; a Control Deployment Manager (CDM) monitoring at least one data transmission metric associated with the first socket; the CDM determining, based on the at least one monitored data transmission metric, that there is a more optimal deployment of the first VNF; and responsive to the determining, the NUMA system re-deploying the first VNF to at least one other core.

Example 2 includes the subject matter of Example 1, and wherein the at least one data transmission metric pertains to data transmission rates from the first socket to a second socket.

Example 3 includes the subject matter of any of Examples 1-2 and wherein the second socket is on the host.

Example 4 includes the subject matter of any of Examples 1-2 and wherein the second socket is on another host.

Example 5 includes the subject matter of any of Examples 1-4 and wherein the at least one other core is on the first CPU.

Example 6 includes the subject matter of any of Examples 1-4 and wherein the at least one other core is on a second CPU.

Example 7 includes the subject matter of any of Examples 1-6 and wherein the computer-implemented method further comprises: the CDM re-monitoring the at least one data transmission metric associated with the first VNF after re-deployment; the CDM determining, based on the at least one monitored data transmission metric, that there is a more optimal deployment of the first VNF; and responsive to the determination, the NUMA system re-deploying the first VNF to at least one other core.

Example 8 includes the subject matter of any of Examples 1-7 and wherein re-deploying the first VNF to at least one other core includes swapping the first VNF deployment with a third VNF deployment.

Example 9 includes a non-uniform memory access (NUMA) system comprising: a first host having a first socket and a second socket, wherein a first virtual network function (VNF) is deployed to at least one core of a first central processing unit (CPU) on the first socket of the first host; and a Control Deployment Manager (CDM) for monitoring at least one data transmission metric associated with the first socket and determining, based on the at least one monitored data transmission metric, that there is a more optimal deployment of the first VNF, wherein the first VNF is re-deployed to at least one other core based on the determining.

Example 10 includes the subject matter of Example 9 and wherein the at least one data transmission metric pertains to data transmission rates from the first socket to a second socket.

Example 11 includes the subject matter of Example 9 and wherein the at least one data transmission metric pertains to data transmission rates from the first host to a second host.

Example 12 includes the subject matter of any of Examples 9-11 and wherein the at least one other core is on the first CPU.

Example 13 includes the subject matter of any of Examples 9-11 and wherein the at least one other core is on a second CPU on the first host.

Example 14 includes the subject matter of any of Examples 9-13 and wherein the at least one other core is on a second CPU on a second host.

Example 15 includes the subject matter of any of Examples 9-14 and wherein the re-deployment of the first VNF includes a swapping of the first VNF deployment with a third VNF deployment.

Example 16 includes a computer-implemented method comprising: a non-uniform memory access (NUMA) system deploying a first virtual machine (VM) to a first socket of a first host; the NUMA system deploying a second VM to a first socket of a second host; the first and second VMs communicating with each other; a Control Deployment Manager (CDM) monitoring at least one data transmission metric associated with the first socket; the CDM determining, based on the at least one monitored data transmission metric, that there is a more optimal deployment of the VMs; responsive to the determining, the NUMA system migrating the second VM to the first host; the CDM determining, based on the at least one monitored data transmission metric, that there is a more optimal deployment of the VMs; and the NUMA system swapping the second VM with a third VM.

Example 17 includes the subject matter of Example 16 and wherein the at least one data transmission metric pertains to data transmission rates associated with the first socket.

Example 18 includes the subject matter of any of Examples 16-17 and wherein the second VM is migrated to a second socket on the first host.

Example 19 includes the subject matter of any of Examples 16-18 and wherein the swapping results in the second VM being deployed to the first socket of the first host.

Example 20 includes the subject matter of any of Examples 16-19 and wherein the swapping results in the third VM being deployed to the second socket of the first host.

Example 21 includes the subject matter of any of Examples 16-20 and wherein the computer-implemented method further comprises: the CDM re-monitoring the at least one data transmission metric associated with the first socket after the swapping; the CDM determining, based on the at least one monitored data transmission metric, that there is a more optimal deployment of the VMs; and responsive to the determination, the NUMA system swapping the third VM with a fourth VM.

Example 22 includes the subject matter of any of Examples 16-21 and wherein the third VM is the first VM.

Example 23 includes a non-uniform memory access (NUMA) system comprising: a first host having a first socket and a second socket, wherein a first virtual machine (VM) is initially deployed to the first socket of the first host; a second host having a first socket, wherein a second VM is initially deployed to the first socket of the second host; and a Control Deployment Manager (CDM) for monitoring at least one data transmission metric associated with the first socket of the first host and determining, based on the at least one monitored data transmission metric, that there is a more optimal deployment of the VMs, wherein the second VM is migrated to the second socket of the first host based on the determining, and further wherein the second VM is swapped with a third VM responsive to the CDM determining, based on the at least one monitored data transmission metric, that there is a more optimal deployment of the VMs after the migrating.

Example 24 includes the subject matter of Example 23 and wherein the at least one data transmission metric pertains to data transmission rates associated with the first socket of the first host.

Example 25 includes the subject matter of any of Examples 23-24 and wherein the third VM is swapped with a fourth VM responsive to the CDM determining, based on the at least one monitored data transmission metric, that there is a more optimal deployment of the VMs after the swapping of the second and third VMs.

Example 26 includes the subject matter of any of Examples 23-25 and wherein the third VM is the first VM.

The previously described versions of the disclosed subject matter have many advantages that were either described or would be apparent to a person of ordinary skill. Even so, all of these advantages or features are not required in all versions of the disclosed apparatus, systems, or methods.

Additionally, this written description makes reference to particular features. It is to be understood that the disclosure in this specification includes all possible combinations of those particular features. For example, where a particular feature is disclosed in the context of a particular aspect or embodiment, that feature can also be used, to the extent possible, in the context of other aspects and embodiments.

Also, when reference is made in this application to a method having two or more defined steps or operations, the defined steps or operations can be carried out in any order or simultaneously, unless the context excludes those possibilities.

Embodiments of the disclosed technology may be incorporated in various types of architectures. For example, certain embodiments may be implemented as any of or a combination of the following: one or more microchips or integrated circuits interconnected using a motherboard, a graphics and/or video processor, a multicore processor, hardwired logic, software stored by a memory device and executed by a microprocessor, firmware, an application specific integrated circuit (ASIC), and/or a field programmable gate array (FPGA). The term “logic” as used herein may include, by way of example, software, hardware, or any combination thereof.

Although specific embodiments have been illustrated and described herein, it will be appreciated by those of ordinary skill in the art that a wide variety of alternate and/or equivalent implementations may be substituted for the specific embodiments shown and described without departing from the scope of the embodiments of the disclosed technology. This application is intended to cover any adaptations or variations of the embodiments illustrated and described herein. Therefore, it is manifestly intended that embodiments of the disclosed technology be limited only by the following claims and equivalents thereof.

We claim:

1. A computer-implemented method, comprising:
a system deploying a first virtual machine (VM) to at least one core of a first central processing unit (CPU) on a first socket of a host;
a Control Deployment Manager (CDM) monitoring at least one metric associated with the first socket;
the CDM determining, based on the at least one monitored metric, that there is a more optimal deployment of the first VM; and
responsive to the determining, the system re-deploying the first VM to at least one other core.

2. The computer-implemented method of claim 1, wherein the at least one metric pertains to data transmission rates from the first socket to a second socket.

3. The computer-implemented method of claim 2, wherein the second socket is on the host.

4. The computer-implemented method of claim 2, wherein the second socket is on another host.

5. The computer-implemented method of claim 1, wherein the at least one other core is on the first CPU.

6. The computer-implemented method of claim 1, wherein the at least one other core is on a second CPU.

7. The computer-implemented method of claim 1, further comprising:
the CDM re-monitoring the at least one data transmission metric associated with the first VM after re-deployment;
the CDM determining, based on the at least one monitored data transmission metric, that there is a more optimal deployment of the first VM; and
responsive to the determination, the system re-deploying the first VM to at least one other core.

8. The computer-implemented method of claim 7, wherein re-deploying the first VM to at least one other core includes swapping the first VM deployment with a third VM deployment.

9. The computer-implemented method of claim 1, wherein the system is a non-uniform memory access (NUMA) system.

10. The computer-implemented method of claim 1, wherein the first VM includes a first virtual network function (VNF).

11. The computer-implemented method of claim 1, wherein the at least one metric includes at least one of a group consisting of: interconnect data rates, cache hit rates, and cache miss rates.

12. A non-uniform memory access (NUMA) system, comprising:
a first host having a first socket and a second socket, wherein a first virtual machine (VM) is deployed to at least one core of a first central processing unit (CPU) on the first socket of the first host; and
a Control Deployment Manager (CDM) for monitoring at least one data transmission metric associated with the first socket and determining, based on the at least one monitored metric, that there is a more optimal deployment of the first VM, wherein the first VM is re-deployed to at least one other core based on the determining.

13. The NUMA system of claim 12, wherein the at least one other core is on the first CPU.

14. The NUMA system of claim 12, wherein the at least one other core is on a second CPU on the first host.

15. The NUMA system of claim 12, wherein the at least one other core is on a second CPU on a second host.

16. The NUMA system of claim 12, wherein the re-deployment of the first VM includes a swapping of the first VM deployment with a third VM deployment.

17. The NUMA system of claim 12, wherein the first VM includes a virtual network function (VNF).

18. A computer-implemented method, comprising:
a system deploying a first virtual machine (VM) to a first socket of a first host;
the system deploying a second VM to a first socket of a second host;
the first and second VMs communicating with each other;
a Control Deployment Manager (CDM) monitoring at least one metric associated with the first socket;
the CDM determining, based on the at least one monitored metric, that there is a more optimal deployment of the VMs;
responsive to the determining, the system migrating the second VM to the first host;
the CDM determining, based on the at least one monitored metric, that there is a more optimal deployment of the VMs; and
the system swapping the second VM with a third VM.

19. The computer-implemented method of claim 18, wherein the at least one data transmission metric pertains to data transmission rates associated with the first socket.

20. The computer-implemented method of claim 18, wherein the second VM is migrated to a second socket on the first host.

21. The computer-implemented method of claim 19, wherein the swapping results in the second VM being deployed to the first socket of the first host.

22. The computer-implemented method of claim 20, wherein the swapping results in the third VM being deployed to the second socket of the first host.

23. The computer-implemented method of claim 22, further comprising:
the CDM re-monitoring the at least one data transmission metric associated with the first socket after the swapping;
the CDM determining, based on the at least one monitored data transmission metric, that there is a more optimal deployment of the VMs; and
responsive to the determination, the system swapping the third VM with a fourth VM.

24. The computer-implemented method of claim 23, wherein the third VM is the first VM.

25. The computer-implemented method of claim 18, wherein the system is a non-uniform memory access (NUMA) system.

26. The computer-implemented method of claim 18, wherein the at least one metric includes at least one of a group consisting of: interconnect data rates, cache hit rates, and cache miss rates.

27. A non-uniform memory access (NUMA) system, comprising:
a first host having a first socket and a second socket, wherein a first virtual machine (VM) is initially deployed to the first socket of the first host;
a second host having a first socket, wherein a second VM is initially deployed to the first socket of the second host; and
a Control Deployment Manager (CDM) for monitoring at least one metric associated with the first socket of the first host and determining, based on the at least one monitored metric, that there is a more optimal deployment of the VMs, wherein the second VM is migrated to the second socket of the first host based on the determining, and further wherein the second VM is swapped with a third VM responsive to the CDM determining, based on the at least one monitored metric, that there is a more optimal deployment of the VMs after the migrating.

28. The NUMA system of claim 27, wherein the third VM is swapped with a fourth VM responsive to the CDM determining, based on the at least one monitored metric, that there is a more optimal deployment of the VMs after the swapping of the second and third VMs.

29. The NUMA system of claim 27, wherein the third VM is the first VM.

30. The NUMA system of claim 27, wherein the first VM includes a virtual network function (VNF).
